(19) United States
(12) Patent Application Publication
(10) Pub. No.: US 2009/0198573 A1
(43) Pub. Date: Aug. 6, 2009

(54) Advertisement Insertion System and Method

(75) Inventor: David Fox, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: iWin, Inc., San Francisco, CA (US)

(21) Appl. No.: 12/023,361

(22) Filed: Jan. 31, 2008

(51) Int. Cl. A63F 9/24; G06Q 30/00

(52) U.S. Cl. 705/14; 463/31

(57) ABSTRACT

A method for presenting an advertisement during a video game. A rendering library used by the video game is renamed to a different name. A replacement library is named to the same name as the rendering library before the rendering library was renamed. The replacement library is coupled to the rendering library through an advertisement engine. Buffer data is retrieved from a video buffer and compared to predefined data that indicates a game state during which the advertisement can be presented. If the buffer data corresponds to the predefined data, then an advertisement is sent from the advertisement engine to the rendering library.

### FIELD OF THE INVENTION

The invention relates generally to the field of advertisement software systems, and more particularly, to an advertisement software system for displaying advertisements inside videogames.

### BACKGROUND

As technologies underlying videogames and expectations surrounding game plays have evolved in the past decade, videogames have made substantial gains in both realism and general acceptance by the mainstream audience worldwide. Once catering to a rather narrowly defined audience, videogames are now a multibillion dollar industry that is growing every year. New types of consumers who rarely played videogames, such as women and the elderly, are now beginning to take interest and participate in this form of entertainment. As the audience for videogames has grown and broadened, in-game advertising has become increasingly attractive economically.

With more and more people turning their attention to videogames and away from traditional mass media, companies across a wide array of industries are trying to discover ways to more effectively promote their products and services through videogames. For example, Electronic Arts, whose profits were dominated by retail sales, is now focusing on creating in-game advertisement opportunities in games such as “The Sims” to sell to companies whose products are more or less a part of everyday American life, such as McDonalds. On the other side of the equation, companies, such as Cadillac, that were once hesitant about the value of exposures in videogames are now contracting with game developers to specifically place their products in relevant videogames to expand their customer bases. However, there are numerous barriers impeding the integration of advertisements into videogames.

One such barrier is the complexity added to the development cycle by taking advertisement placement into consideration. Generally, videogames contain components to process graphics, sound, artificial intelligence, physics, load balancing, etc. If the capability to provide in-game advertisements is to be added during the game's development, then the developers must spend resources on the integration and speculate where and when vendors might be interested in placing their advertisements, such as on the side of an in-game building, on an in-game pedestrian's t-shirt, etc. This can increasing the complexity of the game and add cost and time to the development process.

Another barrier is the challenge faced by companies who are trying to decide whether to purchase advertisement opportunities in a particular videogame. A development cycle could substantially separate the time when advertisements are finalized and the time when they are first viewed by consumers. So unless a company is only interested in name recognition for the company, such as displaying just the Sony logo without any information pertaining to a specific product, this could necessitate a great level of market trend speculation on the market demand for products akin to the product to be advertised, which inevitably would results in some ads being outdated by the time the game is released.

Even if the abovementioned barriers are addressed, many existing games cannot take advantage of this newly emerged advertising market. This is because many existing games do not have the capability to dynamically update and insert advertisements. Other legacy games have hard coded, non-dynamic embedded advertisements that are simply outdated. While significant technological advances have taken place in games targeting the traditional audiences (such as console games and Massive Multiplayer Online Role Playing Games), the games that contributed most to the acceptance of the gaming industry by the mainstream public are still largely “casual games.” Casual games are simple to learn and often provided free of charge over the Internet. These casual games are often legacy games that have been ported from their original development languages to Java or ActiveX, so they can be played on a website or downloaded and ran on a modem operating system. Without potentially significant reprogramming, these games that dominate the newly expanded portion of the gaming market would not be able to take advantage of the unique position that they occupy.

Known systems in the field of in-game advertising fail to overcome these problems. For example, Double Fusion (by Double Fusion, Inc.) is a Software Development Kit (SDK) that a developer can use during the development cycle to add advertising capabilities to their games. It allows a developer to mark certain locations within the game for advertisement placement and such that the advertisements can be filled in dynamically at runtime. Unlike other systems that hard code non-dynamic, static advertisements into a game at development time, Double Fusion can provide a dynamic, live advertising solution for games. However, Double Fusion is not useful for the large body of games whose development cycle has ended: legacy games. What is needed is a system that can dynamically insert advertisements into legacy games, such as casual games. Such a solution would have to be applicable outside of the game development process.

Accordingly, there is a need for an advertisement system for videogames that can be applied to videogames after they have been completed without requiring developers to divert their attention from their work on the game itself during the development cycle, relieve the interested companies from the requirement of market trend speculations by allowing their advertisements to be dynamically inserted into the game at runtime, and provide a way to add advertising capabilities to existing, non-advertisement-enabled games without the need to reprogram these games.

### BRIEF DESCRIPTION OF THE DRAWINGS

FIG. 1 is a system layout diagram of an embodiment of the invention using rendering and replacement libraries.

FIG. 2 is a flow diagram of an embodiment of the invention using rendering and replacement libraries, consistent with the embodiment illustrated in FIG. 1.

FIG. 3 is a system layout diagram of an embodiment of the invention using a rendering module.

FIG. 4 is a flow diagram of an embodiment of the invention using a rendering module, consistent with the embodiment illustrated in FIG. 3.

### DETAILED DESCRIPTION

In accordance with an embodiment of the present invention, a system can dynamically insert advertisements into videogames and can be applied outside of the game development cycle. In some embodiments, the video games were developed without built-in support for advertisement insertions, such as legacy games. Those games provide only functionalities essential to the game, i.e. graphics and audio of the game levels, mechanisms to accept and interpret inputs, artificial intelligence modules, etc. Some examples of such legacy games may include Pac Man, Doom and SimCity. In other embodiments, the video games may have some level of built-in support for advertisement insertions in addition to the essential gaming functionalities. Existing games generally use hard coded insertion schemes to place predetermined advertisements at certain in-game locations, some typical examples may include billboards in a driving game as in Gran Turismo, establishments bearing vendor logos in role playing games as in The Sims, and placement of vendor labels on physical 3D objects such as bottles and boxes as in Counter Strike. Other games with built-in advertising capabilities may also have the ability to connect to an advertisement server via the Internet to update and replace those predetermined advertisements. For illustrative purposes, embodiments of the present invention are described in terms of legacy games. However, those skilled in the art will appreciate that the techniques of the invention can be used for all types of games, regardless of their existing advertising capabilities, execution platforms, genre, etc. In addition, those skilled in the art will appreciate that the techniques of the invention can be used on other presentation applications bearing similar characteristics to games, e.g., having states where an advertisement can be presented to the viewer without having a significantly adverse effect on the main purpose of the presentation.

Various function calls can be made to an execution platform that pertain to graphics rendering, sound synthesis, game logic processing, user input recognition, etc. Embodiments of the present invention can decide which of such function calls are processed. This can depend on the source of the function call and whether an advertisement is being rendered to a player. When an advertisement is being rendered, embodiments of the present invention can override all or a subset of function calls made by a videogame module. For example, if an advertisement entails only visual representation, then one embodiment might only override the graphics rendering function calls from the videogame module, while continuing to process other videogame function calls. User inputs can also be ignored so that players cannot disrupt the display of the advertisement and/or interact with the game while the advertisement is being displayed.

Embodiments of the invention may choose to override communication channels in various degrees, from partial overrides and complete replacements, depending on their particular needs and implementation. Take the graphics rendering channel for example. One embodiment might choose to override a portion of the drawing area occupied by a game, such as a box at the center or a bar shaped area at the top, and replace it with advertisements. Alternatively, another embodiment might choose to replace the entire drawing area with advertisements. In yet another embodiment, advertisements might occupy either a portion of or the entire drawing area with some level of transparency to show the underlying game graphics in various ways. Some examples of ways advertisements can be mixed with the game include turning the portion of the game under the advertisements into grayscale, blurring the portion, generally subduing the colors, etc. How much of a communication channel should be overridden and in what manner can be determined by the embodiments generally, the advertisements specifically, or a combination thereof.

Decisions on when to insert advertisements depend at least in part on one or more available game state definitions. In one embodiment, a game state definition might include a bitmap pattern of a portion of or the entire drawing area that the associated game is able to match to some defined degree under certain circumstances. Exemplar patterns might include a screenshot of the entire “Game Over” screen for which at least 90% of the pixels must match, or just the portion that contains the phrase “Game Over” for which an absolute (100%) match must exist to constitute a game state match. In another embodiment, the definition might include a graphics pattern to be matched generally, the pattern defined by means such as mathematical equations, color contrasts thresholds, object placements, etc. One example of such a definition might be described in plain language as “extract the red channel of the image, locate all the enclosures formed by the red channel, and calculate the distance between nearby enclosures from their respective centers. If the average of the distance is between 50 and 100 pixels, then indicate a game state match.” In yet another embodiment, the set of game state definitions might be a combination of absolute- and partial-match bitmap patterns and graphics patterns.

Advertisements to be displayed during a particular game state may be selected based on one or more criteria, including dimension, duration, content, user preference, user profile, user game score, historical data pertaining to user behavior in the game and on the Internet, geo-location data associated with the user, time-of-day, date, etc. In one embodiment, such criteria are provided as a part of the game state definitions. For example, a particular game state might only allow still advertisements, as opposed to videos, to be displayed. In another embodiment, at least a portion of the criteria is based on information outside of the game state definitions. Examples of such external criteria may include parental control settings, user interests inferred from their previous interactions with various advertisements, general dimensional limitations placed by the embodiment's implementation, etc.

Advertisements in accordance with embodiments of the present invention can be interactive. An advertisement can contain one or more active object that, when selected by a user, trigger a function on the user computer. For example, an advertisement can contain a hyperlink that, when selected, launches a browser (or browser window) and retrieves content available on the web. The advertisement can also include multimedia content, such as video, audio-only, text, animation, graphics, etc. The placement of the advertisement or an active area in the advertisement, when selected by a user, can cause the launch of a video player, and audio player, etc.

Embodiments of the invention may store game state definitions and advertisements locally, remotely, or a combination thereof. In one embodiment, advertisements may be downloaded from a remote advertisement server and game state definitions can be stored locally on the same execution platform as the game. In another embodiment, both advertisements and game state definitions may be locally cached for faster retrieval, and the local caches can be updated periodically from one or more remote servers, such as once a day or during a dynamically defined period characterize by a set of factors including processor idleness, bandwidth availability, etc. In yet another embodiment, game state definitions are downloaded from remote servers as the game is first executed, and then all or a subset of advertisements suitable for the game according to the downloaded definitions are then downloaded. One of ordinary skill in the art will appreciate that any possible combination of downloading, caching and updating schemes can be used in accordance with embodiments of the present invention.

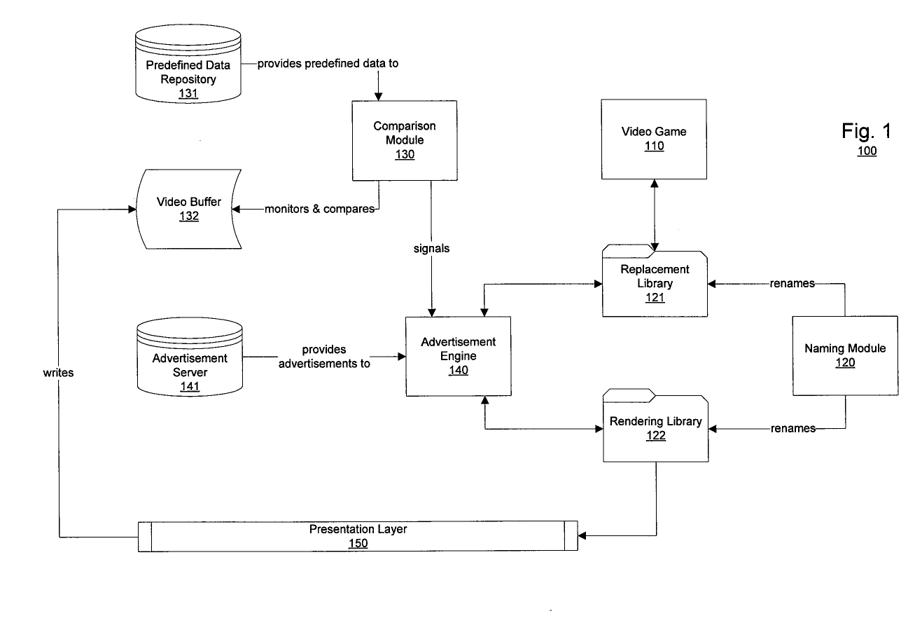

FIG. 1 shows a system layout diagram of an embodiment of the invention using rendering and replacement libraries. Videogame module 110 is coupled to the execution platform's presentation layer 150 through replacement library 121 and rendering library 122. Libraries 121 and 122 are files on the execution platform that can be used to direct presentation layer 150 to present the videogame. An example of a rendering library is a DirectX library from Microsoft. Libraries 121 and 122 are coupled to naming module 120 which renames rendering library 122 to a new name, and replacement library 121 to the original name of the rendering library 122. The reason for this operation is that, in this embodiment, videogame module 110 is designed to use a library with a predetermined identifier, e.g., the name of rendering library 122. In other words, when videogame module 110 is executed, function calls will be made to a specific rendering library, such as Direct3D.dll. In accordance with an embodiment of the present invention, this predefined library is replaced with an interface shell, also called the replacement library. This can be done by renaming the predefined library (e.g., Direct3D.dll is renamed Direct3DX.dll) and giving the interface shell the same name as the predefined library (in this example, Direct3D.dll). This permits function calls normally directed to the predefined library to first be processed by the replacement library, while keeping the original, predefined library available to perform its function when needed.

Replacement library 121 and rendering library 122 are further coupled to advertisement engine 140. When the game is in a state in which advertisements are not being presented (e.g., during game play), function calls made by videogame module 110 are sent to replacement library 121, which sends them to advertisement engine 140, which in turn passes them to rendering library 122.

Advertisement engine 140 is coupled to and accepts inputs from comparison module 130. Comparison module 130 monitors video buffer 132, and compares its contents to pattern data stored in predefined data repository 131. The purpose of this comparison is to identify when the game state is appropriate to display an advertisement to the player. The predefined data repository stores data that can be used to determine when the buffer contains material that indicates a game state suitable for showing an advertisement. Comparison module 130 can make the comparisons dynamically or periodically. For example, a dynamic comparison could be based on the rate of user input, where if the rate crosses a certain threshold, a comparison would be made. When comparison module 130 determines that a match exists between one or more of the patterns stored in predefined data repository 131 and current video buffer 132 it will pass the match information to advertisement engine 140.

Upon receiving the match information, advertisement engine 140 can retrieve one or more advertisements from advertisement server 141 and then make function calls to rendering library 122 to render the advertisement. While rendering the advertisement, function calls made by videogame module 110 can be suspended. This is done so that the execution of rendering commands issued by videogame module 110 will not interfere with the display of the advertisement. When the display of the advertisement is completed (e.g., the advertisement has been rendered and shown for a certain amount of time), advertisement engine 140 can once again resume relaying videogame module 110 function calls from the replacement library to rendering library 122. User inputs (e.g., mouse inputs, keyboard inputs, etc.) received during the presentation of the advertisement can be interpreted by advertisement engine 140, instead of by videogame module 110. This can be done using replacement library 121 to ensure that any action by a user to select an advertisement, for example, results in the correct action (e.g., launching a browser or browser window) and that spurious mouse clicks do not interfere with the advertisement.

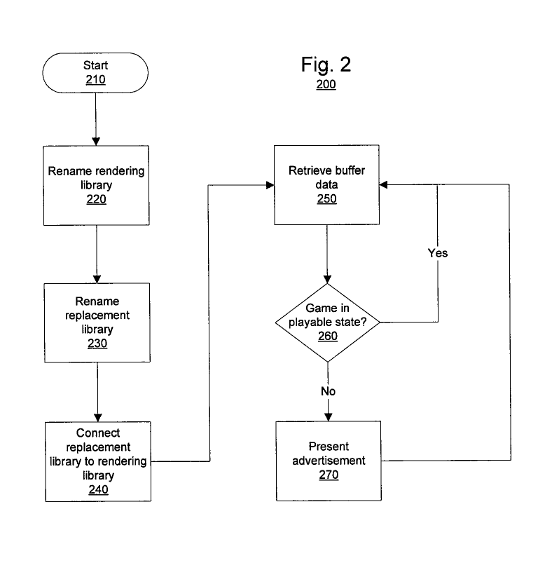

FIG. 2 illustrates one possible process that could be followed by the system of FIG. 1, as described above. Initially, rendering library 122 can be renamed to a different name by naming module 120, step 220. Replacement library 121 can be renamed to the original name of rendering library 122 using naming module 120, step 230. When videogame module 110 executes, comparison module 130 can retrieve buffer data from video buffer 132, at step 240. It can determine whether the videogame is in a playable state by comparing the retrieved video buffer data to pattern data stored in predefined data repository 131, step 250. If no match exists, then it will repeat steps 240 and 250 until a match is detected. If at least one match is found at step 250, then comparison module 130 can indicate that match was found to advertisement engine 140. At step 260, advertisement engine 140 can retrieve at least one advertisement from advertisement server 141 and use rendering library 122 to render the advertisement. Function calls from the videogame module 110 that are received through replacement library 121 can be overridden during the display of the advertisement. Upon completion of presenting the advertisement, advertisement engine 140 can resume relaying data between replacement library 121 and rendering library 122 while comparison module 130 can go back to step 240 and monitors video buffer 132 for matches.

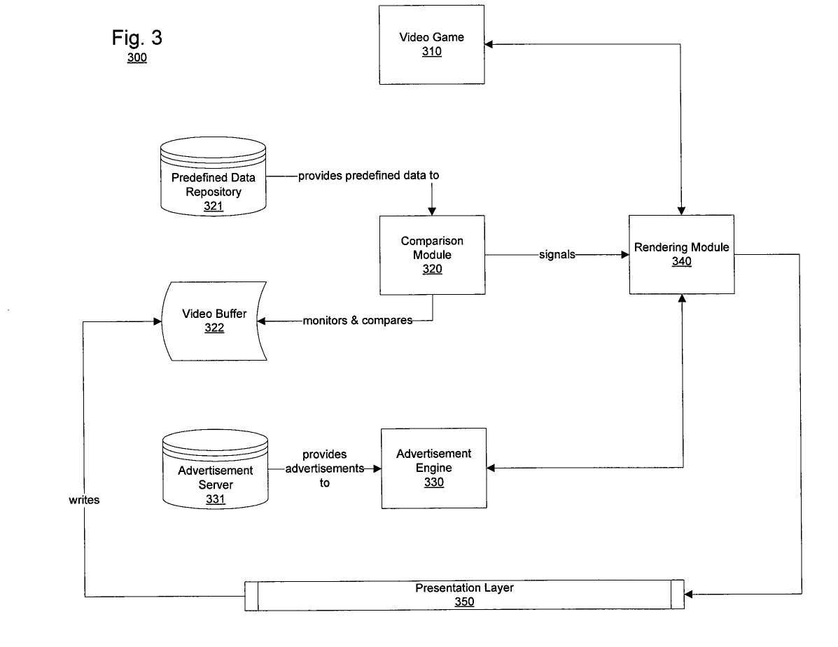

FIG. 3 illustrates another possible system level embodiment of the invention. Videogame module 310 can be connected to the execution platform's presentation layer 350 through rendering module 340. Similarly, advertisement engine 330 can be connected to presentation layer 350 through rendering module 340. Rendering module 340 is able to selectively process the function calls made by videogame module 310 and advertisement engine 330. The selection between the two can be based on inputs that rendering module 340 can receive from comparison module 320. Comparison module 320 can monitor video buffer 322 and compare its contents to pattern data stored in predefined data repository 321. This can be done periodically, on a dynamic basis, etc. Video buffer 322 can be written by presentation layer 350. If comparison module 320 determines that a match exists between one or more of the patterns stored in predefined data repository 321 and video buffer 322, it can pass match information to rendering module 340. A match can indicate that the videogame is in a state appropriate to show an advertisement.

Upon receiving the match information, rendering module 340 can signal to advertisement engine 330 to provide at least one advertisement to be rendered. In response, advertisement engine 330 can retrieve one or more advertisements from advertisement server 331 and then make function calls to rendering module 340 that can cause the advertisement to be shown. Rendering module 340 can cause function calls made by videogame module 310 that would disrupt the rendering of the advertisement to be ignored. Any user inputs received by rendering module 340 during the presentation of the advertisement can be relayed to and interpreted by advertisement engine 330 instead of videogame module 310. When the advertisement has been completed (e.g., it has been shown for a given period of time, a video file has completed playing, a jingle has finished, etc.), rendering module 340 can once again resume processing function calls from videogame module 310 to render the game.

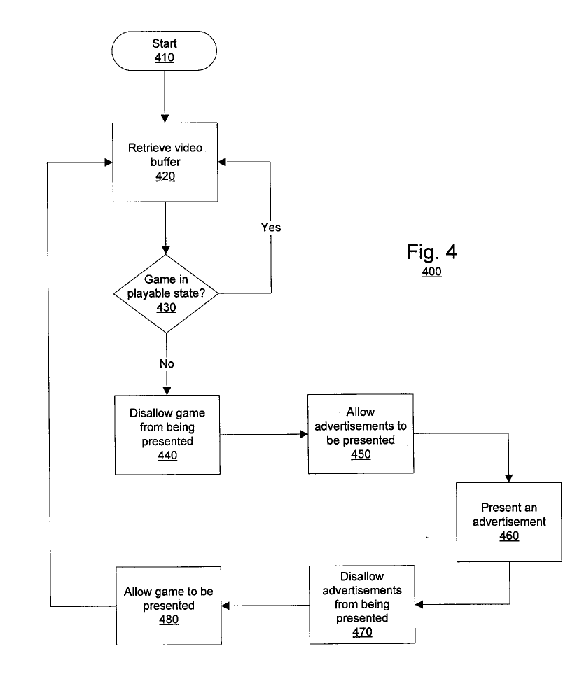

FIG. 4 illustrates one possible process that could be followed by the system of FIG. 3. Comparison module 320 can retrieve buffer data from video buffer 322, step 420. Comparison module 320 can determine if the videogame is in a playable state by comparing video buffer 322 to pattern data stored in predefined data repository 321, step 430. If no match is found, then it will repeat steps 420 and 430 until at least one match is detected. If at least one match is found at step 430, then comparison module 320 can send match information to rendering module 340, which can in turn signal to advertisement engine 330 to fetch an advertisement to be shown to the player. In response, advertisement engine 330 can retrieve one or more advertisements from advertisement server 331, step 440. It can then make function calls to rendering module 340 that can cause the advertisement to be shown, step 450. Rendering module 340 can cause function calls made by videogame module 310 that would disrupt the rendering of the advertisement to be ignored, 460. Any user inputs received by rendering module 340 during the presentation of the advertisement can be relayed to and interpreted by advertisement engine 330 instead of videogame module 310. The advertisement can be presented to the player, step 470. When the advertisement has been completed (e.g., it has been shown for a given period of time, a video file has completed playing, a jingle has finished, etc.), rendering module 340 can once again resume processing function calls from videogame module 310 to render the game, step 480.

From the foregoing, those skilled in the art will appreciate that, although specific embodiments have been described herein for purposes of illustration, these illustrations in no way limit the scope of the claims. Upon reading the disclosure those of skill in the art will understand that the claims encompass numerous variations that are within the spirit and scope of the invention. For example, the present invention is not limited to serving advertisements. Any content, including code, can be served to a user in accordance with the present invention. For example, an embodiment of the present invention can serve widgets. Also, the present invention is not limited to videogames. For example, the present invention can be used to insert content of any kind into streamed video, such as that found on YouTube at www.youtube.com.

What is claimed is:

1. A method for presenting an advertisement during a video game, comprising:
renaming a rendering library used by the video game to a different name;
renaming a replacement library to the same name as the rendering library before the rendering library was renamed;
coupling the replacement library to the rendering library through an advertisement engine;
retrieving buffer data from a video buffer;
comparing the buffer data with predefined data that indicates a game state during which the advertisement can be presented; and
if the buffer data corresponds to the predefined data, then sending an advertisement from the advertisement engine to the rendering library.

2. The method of claim 1, further comprising sending a request for the advertisement from the advertisement engine to an advertisement server.

3. The method of claim 1, wherein the advertisement is user interactive.

4. The method of claim 1, wherein the advertisement comprises at least one from the group of text, graphics, audio, video and code that is executed or interpreted on the same device on which the advertisement is rendered.

5. The method of claim 1, wherein the advertisement includes a link that, when selected by a user, causes an application to be launched from the group of a browser, an audio player and a video player.

6. A method for presenting an advertisement during a videogame, comprising:
retrieving buffer data from a video buffer;
comparing the buffer data with predefined data that indicates a game state during which the advertisement can be presented;
if the buffer data corresponds to the predefined data, then
processing function calls from an advertisement engine and not processing function calls from a videogame module;
presenting the advertisement; and
after the advertisement is complete, resuming to process the function calls from the videogame module.

7. The method of claim 6, wherein the predefined data comprises an image pattern.

8. The method of claim 6, wherein an advertisement is selected based at least partly on the instance or type of the predefined data to which the buffer data corresponds.

9. The method of claim 6, wherein the advertisement includes a link that, when selected by a user, causes an application to be launched from the group of a browser, a video player and an audio player.

10. The method of claim 6, further comprising sending a request from the advertisement engine to an advertisement server and, in response, receiving an advertisement.

11. The method of claim 6, wherein the advertisement is selected based upon the game state indicated by the predefined data.

12. The method of claim 6, wherein the buffer data corresponds to the predefined data if there is less than a predefined amount of mismatch.

13. A system for presenting an advertisement to a user during a video game, comprising:
a memory storing predefined data;
a comparison module coupled to the memory that retrieves buffer data from a video buffer and compares it to the predefined data stored in the memory;
a naming module that renames a rendering library used by the game to a different name and renames a replacement library to the same name as the rendering library before the rendering library was renamed; and
an advertisement engine coupled to the rendering library, the replacement library and the comparison module, wherein the advertisement engine relays information between the rendering library and the replacement library, and sends the advertisement to the rendering library if the comparison module indicates that the retrieved buffer data corresponds to the predefined data stored in the memory.

14. A system for presenting an advertisement to a user during a video game, comprising:
a memory storing predefined data;
a comparison module coupled to the memory that retrieves buffer data from a video buffer and compares it to the predefined data stored in the memory;
an advertisement engine adapted to present the advertisement; and
a rendering module coupled to the video game, the advertisement engine and the comparison module, wherein the rendering module renders game information from the video game, and the advertisement from the advertisement engine if the comparison module indicates that the retrieved buffer data corresponds to the predefined data stored in the memory.
